(19) United States
(12) Patent Application Publication
(10) Pub. No.: US 2024/0246306 A1
(43) Pub. Date: Jul. 25, 2024

(54) MOLD FOR FORMING A TIRE AND TIRE PRODUCTION METHOD

(71) Applicant: BRIDGESTONE CORPORATION, Chuo-ku, Tokyo (JP)

(72) Inventor: Yasuyuki ISHIHARA, Chuo-ku, Tokyo (JP)

(73) Assignee: BRIDGESTONE CORPORATION, Chuo-ku, Tokyo (JP)

(21) Appl. No.: 18/563,968

(22) PCT Filed: Nov. 24, 2021
(86) PCT No.: PCT/JP2021/043052

§ 371 Date: Nov. 24, 2023

(30) Foreign Application Priority Data
Jun. 22, 2021 (JP) 2021-103650

(51) Int. Cl. B29D 30/06; B29C 33/26

(52) U.S. Cl. CPC B29D 30/0606; B29C 33/26; B29D 2030/0607

(57) ABSTRACT

Provided are a mold for forming a tire including an annular tread molding part a plurality of segments divided into arranged in a circumferential direction arranged in a circumferential direction, and a tire production method and using the same. The mold for forming a tire includes a rotatable shaft perpendicular to a direction of movement of the segment and also to the axis of the tread molding part; a base member supporting the segment to be rotatable around the rotatable shaft; and an external force application mechanism which, when the tread molding part is opened, applies external force to the segment to rotate the segment toward a direction in which a side of the other end of the segment in the direction of the axis is moved around the rotatable shaft toward a radially outer side.

### TECHNICAL FIELD

This disclosure relates to a mold for forming a tire and a tire production method.

### BACKGROUND

In a known conventional mold for forming a tire for use in vulcanization molding of an unvulcanized raw tire to produce a tire, it is known that an annular tread molding part (a tread mold) for forming a tread of a tire is divided into a plurality of segments arranged in a circumferential direction and is configured to be opened and closed by moving each of the segments in a radial direction (for example, see PTLs 1 to 3).

### CITATION LIST

### Patent Literature

PTL 1: JP 2000-326332 A
PTL 2: JP 2000-334740 A
PTL 3: JP 2009-149079 A

### SUMMARY

### Technical Problem

However, in the above-described conventional mold for forming a tire or the above-described conventional tire production method, when the tire is released from the tread molding part after vulcanization molding, each of the segments is moved toward a radially outer side with maintaining the orientation of each of the segments to a tread of the tire. As a result, all portions of the tread design surface for forming the tread of the segment are to peel off from the tread simultaneously. Therefore, there has been a problem in that a great driving force is required for driving the segments in the initial stage of mold releasing of the tire.

This disclosure has been accomplished in view of the above-described problem and it is an object of this disclosure to provide a mold for forming a tire and a tire production method which can reduce driving force required for driving the segments in the initial stage of mold releasing of the tire.

### Solution to Problem

The mold for forming the tire of this disclosure is a mold for forming a tire for vulcanization molding of an unvulcanized raw tire into a tire, the mold including an annular tread molding part which is divided into a plurality of segments arranged in a circumferential direction, wherein a rotatable shaft which is provided on a side of one end of the segment in a direction of an axis of the tread molding part and which is perpendicular to a direction of movement of the segment and also to the axis of the tread molding part; a base member supporting the segment to be rotatable around the rotatable shaft; and an external force application mechanism which, when the tread molding part is opened, applies external force to the segment to rotate the segment toward a direction in which a side of the other end of the segment in the direction of the axis is moved around the rotatable shaft toward a radially outer side.

In an embodiment, the mold for forming the tire of this disclosure can be configured in such a way that the external force application mechanism includes a for-rotation spring member for application of spring force as external force to the segment.

In an embodiment, the mold for forming the tire of this disclosure can be configured in such a way that an outer ring which is disposed on a radially outer side of the segment and movable between a retention position at which the segment is retained at a predetermined position and a release position which allows for rotation of the segment around the rotatable shaft toward the radially outer side.

In an embodiment, the mold for forming the tire of this disclosure can be configured in such a way that the mold includes a guide rail supporting the base member to be movable in a radial direction of the tread molding part; and a for-sliding spring member biasing the base member toward a radially outer side of the tread molding part, wherein the segment is moved toward a radially outer side with the segment being rotated about the rotatable shaft.

In an embodiment, the mold for forming the tire of this disclosure can be configured in such a way that when the tread molding part is opened after vulcanization molding of the tire, the first segment is rotated around the first rotatable shaft, and subsequently, the second segment is rotated around the second rotatable shaft.

The tire production method of this disclosure is a tire production method for vulcanization molding of an unvulcanized raw tire to produce a tire by using a mold for forming a tire including an annular tread molding part which is divided into a plurality of segments arranged in a circumferential direction, wherein when the tread molding part is opened after vulcanization molding of the tire, by applying external force to the segment by an external force application mechanism, the tire is released from the tread molding part with the segment being rotated around a rotatable shaft which is provided on a side of one end of the segment in a direction of an axis of the tread molding part and which is perpendicular to a direction of movement of the segment and also to the axis of the tread molding part.

### Advantageous Effect

This disclosure can provide a mold for forming a tire and a tire production method which can reduce driving force required for driving the segments in the initial stage of mold releasing of the tire.

### BRIEF DESCRIPTION OF THE DRAWINGS

In the accompanying drawings:

FIG. 1 is a cross-sectional view of a mold for forming a tire according to an embodiment of this disclosure, which is illustrated in a front view;

FIG. 2 is a cross-sectional view of the tread molding part illustrated in FIG. 1, which is illustrated in a planar view;

FIG. 3 is an enlarged cross-sectional view of detailed structure of the main portion of the mold for forming the tire illustrated in FIG. 1, which is illustrated in a front view;

FIG. 4 is an enlarged cross-sectional view of detailed structure of the main portion of one segment illustrated in FIG. 3, which is illustrated in a front view;

FIG. 5 is a cross-sectional view of the state of the main portion of the mold for forming the tire in the initial stage of mold releasing of the tire, which is illustrated in a planar view; and

FIG. 6 is a cross-sectional view of the state of the main portion of the mold for forming the tire where the mold releasing of the tire is further proceeded from the state illustrated in FIG. 5, which is illustrated in a planar view.

### DETAILED DESCRIPTION

By way of example, a mold for forming a tire and a tire production method according to an embodiment of this disclosure will now be described in detail with reference to the drawings. In this regard, common members and portions appearing in the drawings have the same reference signs.

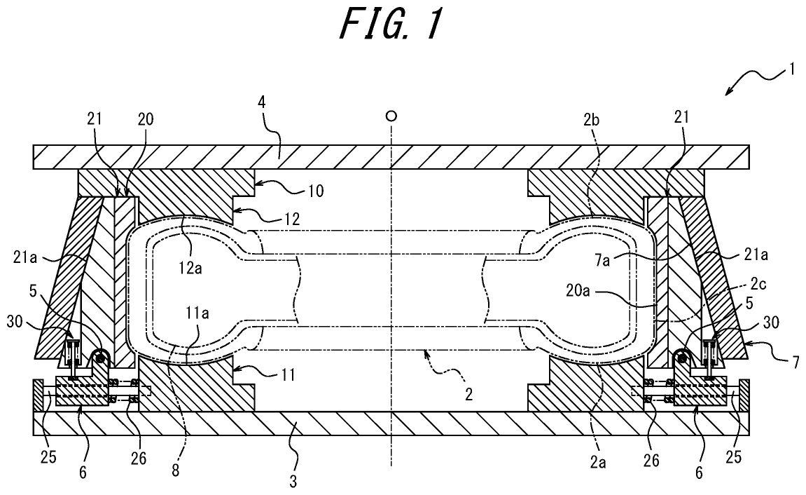

A mold for forming a tire 1 illustrated in FIG. 1 according to an embodiment of this disclosure is for use in forming an unvulcanized (before vulcanization) raw tire based on a synthetic rubber into a predetermined shape with the raw tire being vulcanized to produce a tire 2.

In this regard, the tire 2 is a hollow tire based on a synthetic rubber including a pair of sidewalls 2a, 2b and a tread 2c, and is shaped to provide the interior of the tire 2 with a space for filling of a gas such as air or nitrogen.

The mold for forming the tire 1 includes a sidewall molding part 10 and a tread molding part 20.

For example, the sidewall molding part 10 can include an annular lower sidewall molding part 11 fixed to a top surface of a lower container 3, and an annular upper sidewall molding part 12 fixed to a bottom surface of an upper container 4.

The sidewall molding part 10 can dispose (accommodate) an annular tire 2 or a raw tire between the lower sidewall molding part 11 and the upper sidewall molding part 12 to be in an orientation by which the central axis of the raw tire becomes coaxial with the central axis O of the sidewall molding part 10. The lower sidewall molding part 11 includes a lower sidewall design surface 11a, which is in the form of a ring around the central axis O and is oriented toward the upward direction. The lower sidewall molding part 11 can form an outer surface of a sidewall 2a of one of the tire 2 or the raw tire (any of which is oriented toward the downward direction in FIG. 1) by the lower sidewall design surface 11a. Similarly, the upper sidewall molding part 12 includes an upper sidewall design surface 12a, which is in the form of a ring around the central axis O and is oriented toward the downward direction. The upper sidewall molding part 12 can form an outer surface of a sidewall 2b of the other of the tire 2 or the raw tire (any of which is oriented toward the upward direction in FIG. 1) by the upper sidewall design surface 12a. By moving the upper container 4, from a position illustrated in FIG. 1, upwardly (the direction in which the upper container 4 and the lower container 3 is moved away from each other along the central axis of the tire 2) and relatively to the lower container 3, the sidewall molding part 10 is opened and the tire 2 is released from the sidewall molding part 10. By moving the upper container 4 downwardly to its original position illustrated in FIG. 1, the sidewall molding part 10 in an opened configuration is closed to allow for forming of the tire 2 or the raw tire.

In this regard, modifications can be made to the configuration of the sidewall molding part 10 as appropriate, and examples of such modifications include a configuration in which the sidewall molding part 10 is opened by moving the lower container 3 downwardly and relatively to the upper container 4.

The tread molding part 20 is annular and coaxial with the sidewall molding part 10 and is disposed adjacent to a radially outer side of the lower sidewall molding part 11 and the upper sidewall molding part 12. The inner circumferential surface oriented toward the radially inner side of the tread molding part 20 is a tread design surface 20a for forming an outer circumferential surface of the tread 2c of the tire 2.

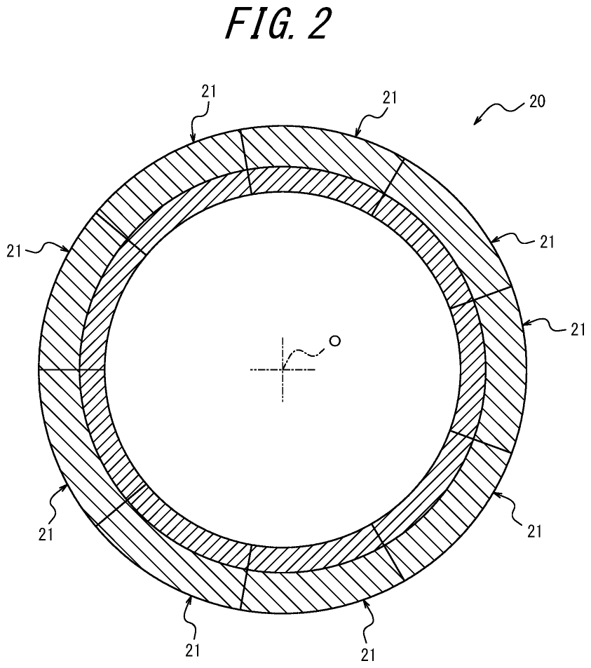

As illustrated in FIG. 2, the tread molding part 20 is divided into a plurality of segments 21 arranged in a circumferential direction. Each of the segments 21 is in the form of arc in a planar view and the segments 21 are combined in a circumferentially arranged manner to constitute a tread molding part 20, which is an annular mold as a whole. In this embodiment, the tread molding part 20 is divided into nine segments 21 having the same length in a circumferential direction. In this regard, the division number of the tread molding part 20 in a circumferential direction is preferably, but not limited to, 7 to 13 and can be changed as appropriate.

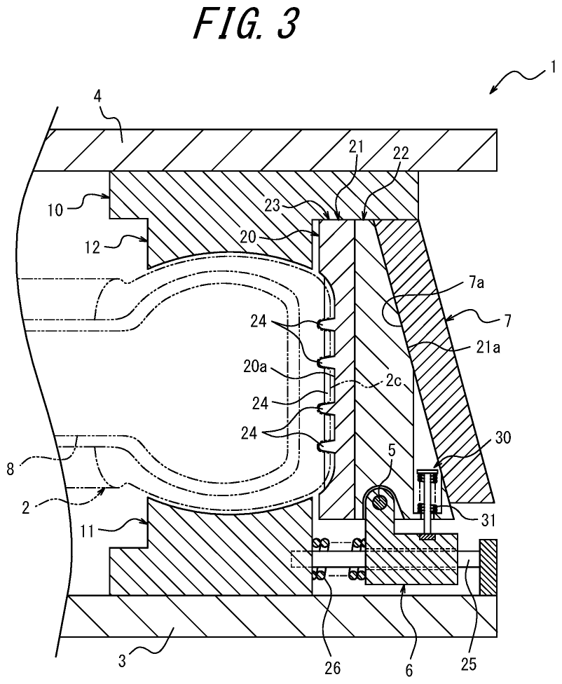

As illustrated in FIG. 3, in this embodiment, each of the plurality of the segments 21 constituting the tread molding part 20 includes a holder 22 and a design surface dividing mold part 23.

The holder 22 can be formed, for example, by cutting a block made of metal such as low carbon steel.

The design surface dividing mold part 23 is a portion which constitutes a tread design surface 20a for forming the tread 2c of the tire 2 and is in the form of arc in a planar view and, and a surface oriented toward the radially inner side constitutes a circumferential divided portion of the tread design surface 20a. The design surface dividing mold part 23 is disposed on the radially inner side of the holder 22 corresponding to the design surface dividing mold part 23, and is fixed to the holder 22 by using a fixing member such as a bolt (not illustrated).

The design surface dividing mold part 23 can be configured in such a way that the tread design surface 20a is provided with a plurality of projections 24 which protrude in a radial direction from the tread design surface 20a toward the radially inner side. The plurality of the projections 24 are used to form, for example, a groove or sipe, which constitutes a tread pattern, on the tread 2c of the tire 2 in vulcanization molding. The plurality of the projections 24 can be of various shapes or sizes (length) tailored to the tread pattern, such as a plurality of projections 24 extending in a tire width direction and a plurality of projections 24 extending in a tire circumferential direction. In this regard, the tread design surface 20a may not be provided with projections 24.

The design surface dividing mold part 23 is preferably formed by casting of a metal material having high thermal conductivity such as, for example, an aluminum alloy. In this case, for example, rib-shaped or blade-shaped projections 24 made of steel can be provided by integrating with the design surface dividing mold part 23 in casting of the design surface dividing mold part 23.

As illustrated in FIG. 3, on the side of one end (in the case illustrated in FIG. 3, the upper end side) in a direction of the axis of the tread molding part 20, each of the segments 21 includes a rotatable shaft 5 which is perpendicular to a direction of movement of the segment 21 (radial direction) and also to the axis of the tread molding part 20. In this embodiment, the rotatable shaft 5 is disposed on the lower end portion of the holder 22.

In the downward direction of each of the segments 21, an individual base member 6 corresponding to the segment 21 is disposed. The rotatable shaft 5 is supported by the base member 6, and thus, the segment 21 is supported by the base member 6 to be rotatable around the rotatable shaft 5. In other words, the segment 21 is rotatable around the rotatable shaft 5 in relation to the base member 6.

The tread molding part 20 can be opened in such a way that after vulcanization molding of the tire 2 in the situation where each of the segments 21 is at a predetermined position, each of the segments 21 is rotated from the predetermined position toward the radially outer side around the rotatable shaft 5 to release the tread 2c from the tread design surface 20a.

In this embodiment, the base member 6 is supported by a guide rail 25 extending in a radial direction of the segment 21, and the guide rail 25 is supported by the lower container 3 and the lower sidewall molding part 11. As a result, can be moved in a radial direction centered on the axis of the tread molding part 20 (central axis O). Also, a for-sliding spring member 26 is disposed between the base member 6 and the lower sidewall molding part 11, and each of the segments 21 is biased toward the radially outer side by the for-sliding spring member 26 corresponding to the each of the segments 21. When the base member 6 is moved in a radial direction moved, the segment 21 supported by the base member 6 is moved in the radial direction together with the base member 6.

Between each of the segments 21 and the base member 6 corresponding to the segment 21, an external force application mechanism 30 is disposed which, when the tread molding part 20 is opened after vulcanization molding of the tire 2, applies external force to the segment 21 to rotate the segment 21 toward a direction in which the side of the upper end of the segment 21 is moved around the rotatable shaft 5 toward the radially outer side.

In this embodiment, the external force application mechanism 30 includes a for-rotation spring member 31 for application of spring force as external force to the segment 21.

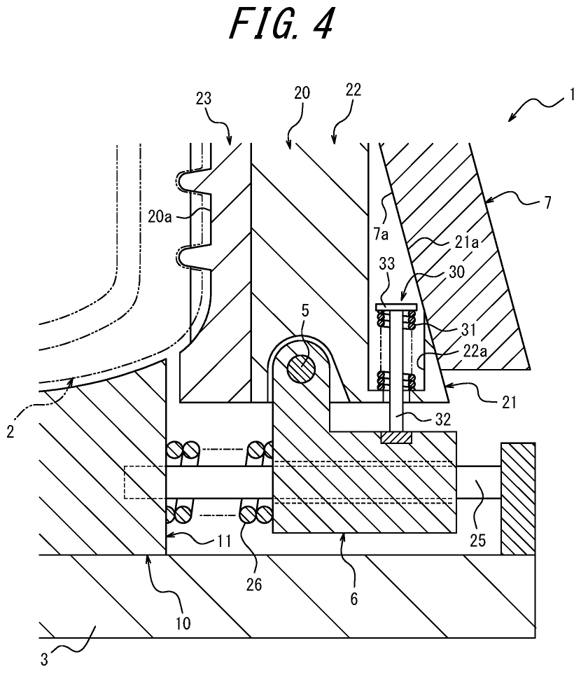

More particularly, as illustrated in FIG. 4, the external force application mechanism 30 includes a shaft-shaped body 32 fixed to the top surface of the base member 6 in such a way that the shaft-shaped body 32 is perpendicular to the top surface and extends in the up-down direction. The shaft-shaped body 32 is inserted into a hole 22a provided in the holder 22 constituting the segment 21 and a flange portion 33 provided on the upper end of the shaft-shaped body 32 is disposed in the hole 22a. The for-rotation spring member 31 is a helical compression spring and disposed to be compressed between the flange portion 33 and a bottom wall of the hole 22a. As a result of this, by the external force application mechanism 30, external force is applied to the segment 21 to rotate the segment 21 toward a direction in which the side of the upper end of the segment 21 is moved around the rotatable shaft 5 toward a radially outer side.

As illustrated in FIGS. 1, 3 and 4, an outer ring 7 is disposed on the radially outer side of each of the segments 21 to retain the segment 21 at a predetermined position against external force applied by the external force application mechanism 30. The outer ring 7 is fixed to an upper container 4 by the medium of the upper sidewall molding part 12 and can be moved, together with the upper container 4, in the up-down direction relatively to the segment 21 supported by the lower container 3 or the base member 6. In this regard, the term “predetermined position” refers to a position at which the segment 21 is in an orientation by which a tread design surface 20a provided on a design surface dividing mold part 23 is continuously connected, in a circumferentially arranged manner, with a tread design surface 20a provided on a design surface dividing mold part 23 of another segment 21.

The inner circumferential surface of the outer ring 7 oriented toward the radially inner side is provided with a tapered surface 7a inclined in such a way that the outer diameter of the tapered surface 7a gradually becomes smaller toward the upward direction. The outer circumferential surface of each of the segments 21 oriented toward the radially outer side is provided with a tapered surface 21a inclined in such a way that the outer diameter of the tapered surface 21a gradually becomes smaller toward the upward direction. In this embodiment, the tapered surface 21a is provided on the outer circumferential surface of the holder 22. When the outer ring 7 is at a retention position illustrated in FIGS. 1 and 3, the tapered surface 7a abuts the tapered surface 21a of the segment 21 to retain the segment 21 at a predetermined position. Also, when the tread molding part 20 is opened by moving the upper container 4 in the upward direction, the outer ring 7 can be moved to a release position located on the side of the upper direction in relation to the retention position together with the upper container 4.

The mold for forming the tire 1 includes a bladder 8 which is disposed in the interior of the raw tire and expanded by supplying of pressurized steam. Also, the mold for forming the tire 1 includes a heater (not illustrated) for heating the sidewall molding part 10 and the tread molding part 20. The location of the heater can be determined as appropriate.

Next, a method for vulcanization molding of a raw tire to produce a tire 2 having a predetermined shape by using a mold for forming a tire 1 having the above-described configuration, that is, a tire production method as an embodiment of this disclosure will be described.

First of all, a sidewall molding part 10 and a tread molding part 20 are opened to dispose a raw tire in the interior of a mold for forming a tire 1, and subsequently, the sidewall molding part 10 and the tread molding part 20 are closed.

Next, a bladder 8 is expanded by supplying pressurized steam to the bladder 8 disposed in the interior of the raw tire. As a result, sidewalls of the raw tire are pressed against a lower sidewall design surface 11a and an upper sidewall design surface 12a of the sidewall molding part 10, respectively, and a tread is pressed against a tread design surface 20a of the tread molding part 20. In this situation, a heater is used to heat the sidewall molding part 10 and the tread molding part 20, and such heat causes vulcanization of the synthetic rubber constituting the raw tire to form a tire 2 having a predetermined shape.

After forming of the tire 2 is completed, the sidewall molding part 10 and the tread molding part 20 are opened to remove a formed tire 2.

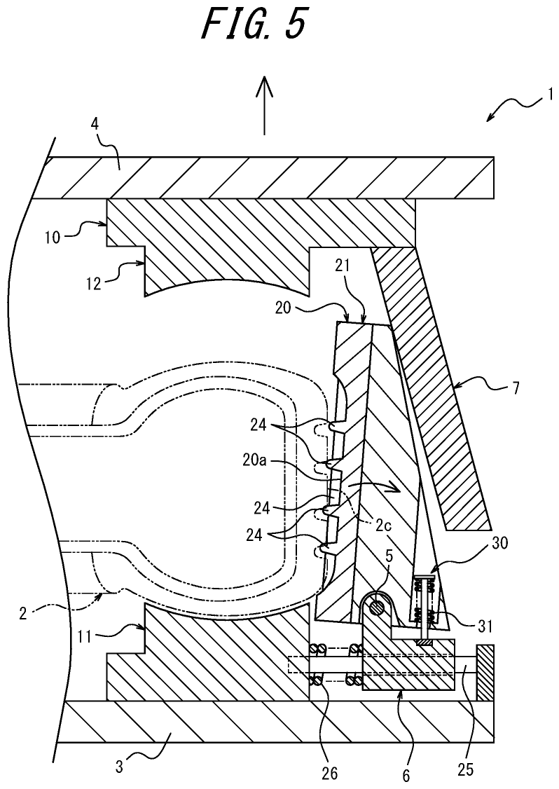

When the outer ring 7 is moved in the upward direction from the retention position toward the release position in relation to each of the segments 21 to open the tread molding part 20 after vulcanization molding of the tire 2, as illustrated in FIG. 5, for rotation of the segment 21 around the rotatable shaft 5 toward the radially outer side is allowed and the segment 21 is driven by the external force application mechanism 30 to spontaneously rotate (panning action) around the rotatable shaft 5 from a predetermined position toward the radially outer side.

As described above, in the tire production method by using the mold for forming the tire 1 of this embodiment, when the tread molding part 20 is opened after vulcanization molding of the tire 2, by applying external force to the segment 21 by the external force application mechanism 30, the tire 2 can be released from the tread molding part 20 with the segment 21 being rotated around the rotatable shaft 5 provided on the side of one end (the side of lower end) of the segment 21. As a result of this, the tread 2c of the tire 2 is gradually released from the side of one end (in FIG. 5, the upper end side) of the design surface dividing mold part 23 in a width direction of the tire 2, followed by releasing from the side of the other end (in FIG. 8, the lower end side). Thus, outside air is gradually introduced between the tread 2c and the tread design surface 20a from the side of one end to allow for reducing mold releasing resistance of the tread 2c of the tire 2 from the tread design surface 20a in the initial stage of mold releasing of the tire 2. Therefore, force required for mold releasing of the tread 2c of the tire 2 from the tread design surface 20a in the initial stage of mold releasing of the tire 2 is reduced, and thus, the tire 2 can be reliably released from the tread molding part 20 by external force applied by the external force application mechanism 30. Also, driving force applied to the segment 21 in mold releasing of the tire 2 can be reduced, and as a result, the external force application mechanism 30 can be downsized to reduce the production costs. In addition, mold releasing resistance of the tread 2c of the tire 2 from the tread design surface 20a can be reduced, and as a result, the generation of residual strain (permanent deformation) in the tire 2 after mold releasing can be suppressed to improve the initial performance of the tire 2.

Also, in mold releasing of the tire 2 from the tread molding part 20, each of the design surface dividing mold parts 23 rotates around the rotatable shaft 5 to reduce undercut resistance of the tread 2c of the tire 2 caused by the projections 24. As a result, driving force required for driving the segments 21 in the initial stage of mold releasing of the tire 2 can be further reduced. In addition, in mold releasing of the tire 2 from the tread molding part 20, defects such as permanent deformation in the formed tread 2c of the tire 2 and the failure of the projections 24 can be suppressed by preventing excessively high undercut resistance.

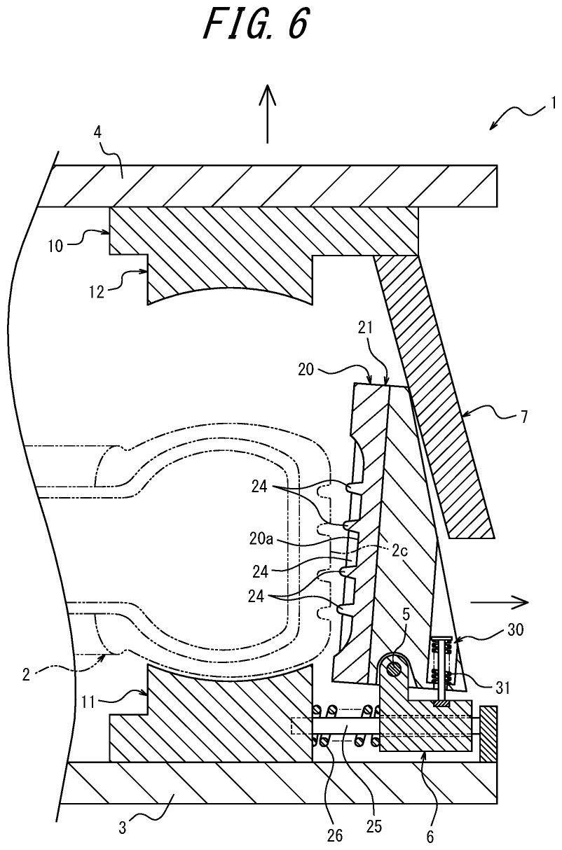

Also, the mold for forming the tire 1 of this embodiment is configured to include a guide rail 25 supporting the base member 6 to be movable in a radial direction of the tread molding part 20; and a for-sliding spring member 26 biasing the base member 6 toward the radially outer side of the tread molding part 20. In the mold for forming the tire 1 of this embodiment, when the outer ring 7 is moved to the release position, as illustrated in FIG. 6, the segment 21 is biased by the for-sliding spring member 26 to be moved together with the base member 6 along the guide rail 25 toward the radially outer side with the segment 21 being spontaneously rotated around the rotatable shaft 5 from a predetermined position toward the radially outer side external force applied by the external force application mechanism 30. As a result of this, in the case where the protruding height of the projections 24 provided on the tread design surface 20a is high, for example, in the case of forming a large tire for use in construction vehicles and the like, undercut resistance of the tread 2c of the tire 2 caused by the projections 24 in rotation of segment 21 around the rotatable shaft 5 can be reduced can be reduced. In addition, in mold releasing of the tire 2, it is possible to move the segment 21 to a position at which obstruction by the projections 24 does not occur, and as a result, mold releasing of the tire 2 can be performed more easily.

In addition, the mold for forming the tire 1 of this embodiment is configured in such a way that the external force application mechanism 30 includes the for-rotation spring member 31 for application of spring force as external force to the segment 21. Therefore, the configuration of the external force application mechanism 30 is simplified, and thus, the production costs of the tire 2 can be further reduced.

In this regard, the external force application mechanism 30 may not be configured to include a for-rotation spring member 31 for application of spring force as external force to the segment 21 and can be configured in such a way that external force is applied to the segment 21 by a driving force source such as an air cylinder.

In addition, the mold for forming the tire 1 of this embodiment is configured to include an outer ring 7 which is disposed on the radially outer side of the segment 21 and movable between a retention position at which the segment 21 is retained at a predetermined position and a release position which allows for rotation of the segment 21 around the rotatable shaft 5 toward the radially outer side. As a result, the mechanism of opening and closing the segment 21 can be simplified to reduce the production costs of the tire 2 further.

The mold for forming the tire 1 of this embodiment can be configured in such a way that when the tread molding part 20 is opened after vulcanization molding of the tire 2, one segment (first segment) 21 of a plurality of segments 21 is rotated around the rotatable shaft 5 (first rotatable shaft) toward a radially outer side, and subsequently, another segment (second segment) 21 of the plurality of the segments 21 is rotated around the rotatable shaft (second rotatable shaft) 5 toward the radially outer side. In other words, the plurality of the segments 21 can be rotated sequentially with time differences between rotation of the segments 21. In this case, the segments 21 can be rotated, in a circumferentially sequential manner, around the rotatable shaft 5 toward the radially outer side in such a way that one segment 21 is rotated around the rotatable shaft 5 toward the radially outer side, and subsequently, a segment 21 adjacent to the segment 21 is rotated around the rotatable shaft 5 toward the radially outer side, and then, a segment 21 adjacent to the segment 21 is rotated around the rotatable shaft 5 toward the radially outer side. As a result of the above-described configuration, in the initial stage of mold releasing of the tire 2, the tread 2c is released from the tread design surface 20c in such a way that portions of the tread 2c is released sequentially in a circumferential direction. In consequence, the tread 2c of the tire 2 can be released from the tread design surface 20a by more small driving force.

As a matter of course, this disclosure is not limited to the above-described embodiment and a variety of modifications are possible without departing from the scope of this disclosure.

For example, in the above-described embodiment, each of the segments 21 is provided with the holder 22, the design surface dividing mold part 23 is fixed to the holder 22, and the holder 22 is supported by the rotatable shaft 5 to be rotatable in relation to the base member 6. However, it is also possible that the holder 22 is not provided, and the design surface dividing mold part 23 is supported on the base member 6 by the rotatable shaft 5.

Also, the tread molding part 20 can be configured in such a way that the base member 6 cannot be moved in a radial direction and the tread molding part 20 is opened purely by rotation of the segment 21 around the rotatable shaft 5.

### REFERENCE SIGNS LIST

1 Mold for forming a tire
2 Tire
2a Sidewall
2b Sidewall
2c Tread
3 Lower container
4 Upper container
5 Rotatable shaft
6 Base member
7 Outer ring
7a Tapered surface
8 Bladder
10 Sidewall molding part
11 Lower sidewall molding part
11a Lower sidewall design surface
12 Upper sidewall molding part
12a Upper sidewall design surface
20 Tread molding part
20a Tread design surface
21 Segment
21a Tapered surface
22 Holder
22a Hole
23 Design surface dividing mold part
24 Projection
25 Guide rail
26 For-sliding spring member
30 External force application mechanism
31 For-rotation spring member
32 Shaft-shaped body
33 Flange portion

1. A mold for forming a tire for vulcanization molding of an unvulcanized raw tire into a tire, the mold comprising an annular tread molding part which is divided into a plurality of segments arranged in a circumferential direction, wherein the mold comprises
a rotatable shaft which is provided on a side of one end of the segment in a direction of an axis of the tread molding part and which is perpendicular to a direction of movement of the segment and also to the axis of the tread molding part; and
a base member supporting the segment to be rotatable around the rotatable shaft; and
an external force application mechanism which, when the tread molding part is opened, applies external force to the segment to rotate the segment toward a direction in which a side of the other end of the segment in the direction of the axis is moved around the rotatable shaft toward a radially outer side.

2. The mold for forming the tire according to claim 1, wherein
the external force application mechanism includes a for-rotation spring member for application of spring force as external force to the segment.

3. The mold for forming the tire according to claim 2, the mold comprising:
an outer ring which is disposed on a radially outer side of the segment and movable between a retention position at which the segment is retained at a predetermined position and a release position which allows for rotation of the segment around the rotatable shaft toward the radially outer side.

4. The mold for forming the tire according to claim 1, the mold comprising:
a guide rail supporting the base member to be movable in a radial direction of the tread molding part; and
a for-sliding spring member biasing the base member toward a radially outer side of the tread molding part, wherein
the segment is moved toward the radially outer side with the segment being rotated around the rotatable shaft.

5. The mold for forming the tire according to claim 1, wherein
when the tread molding part is opened after vulcanization molding of the tire, the first segment is rotated around the first rotatable shaft, and subsequently, the second segment is rotated around the second rotatable shaft.

6. A tire production method for vulcanization molding of an unvulcanized raw tire to produce a tire by using a mold for forming a tire comprising an annular tread molding part which is divided into a plurality of segments arranged in a circumferential direction, wherein
when the tread molding part is opened after vulcanization molding of the tire, by applying external force to the segment by an external force application mechanism, the tire is released from the tread molding part with the segment being rotated around a rotatable shaft which is provided on a side of one end of the segment in a direction of an axis of the tread molding part and which is perpendicular to a direction of movement of the segment and also to the axis of the tread molding part.

7. The mold for forming the tire according to claim 2, the mold comprising:
a guide rail supporting the base member to be movable in a radial direction of the tread molding part; and
a for-sliding spring member biasing the base member toward a radially outer side of the tread molding part, wherein
the segment is moved toward the radially outer side with the segment being rotated around the rotatable shaft.

8. The mold for forming the tire according to claim 3, the mold comprising:
a guide rail supporting the base member to be movable in a radial direction of the tread molding part; and
a for-sliding spring member biasing the base member toward a radially outer side of the tread molding part, wherein
the segment is moved toward the radially outer side with the segment being rotated around the rotatable shaft.

9. The mold for forming the tire according to claim 2, wherein
when the tread molding part is opened after vulcanization molding of the tire, the first segment is rotated around the first rotatable shaft, and subsequently, the second segment is rotated around the second rotatable shaft.

10. The mold for forming the tire according to claim 3, wherein
when the tread molding part is opened after vulcanization molding of the tire, the first segment is rotated around the first rotatable shaft, and subsequently, the second segment is rotated around the second rotatable shaft.

11. The mold for forming the tire according to claim 4, wherein
when the tread molding part is opened after vulcanization molding of the tire, the first segment is rotated around the first rotatable shaft, and subsequently, the second segment is rotated around the second rotatable shaft.
